(19) United States
(12) Patent Application Publication
(10) Pub. No.: US 2022/0314374 A1
(43) Pub. Date: Oct. 6, 2022

(54) PURGE WALL SYSTEM FOR WELDING

(71) Applicant: Blaine WALL, Winnipeg (CA)

(72) Inventor: Blaine WALL, Winnipeg (CA)

(21) Appl. No.: 17/709,513

(22) Filed: Mar. 31, 2022

Related U.S. Application Data
(60) Provisional application No. 63/170,019, filed on Apr. 2, 2021.

(51) Int. Cl. B23K 31/02; B23K 37/00; B23K 35/38

(52) U.S. Cl. CPC B23K 31/027; B23K 37/00; B23K 35/383; B23K 2101/10

(57) ABSTRACT

A system for welding pipe sections together includes first and second disks, each having a central portion and a resilient material outer portion. The central portion is more rigid than the outer portion. An outside dimension and shape of each outer portion is configured to engage an interior of a pipe having an inner dimension that is smaller than the outside dimension of the outer portion to establish a sealed interface between the outer portion and the interior of the first pipe section. The disks establish a chamber that overlaps a weld seam between abutting pipe sections. An inert gas introduced into the chamber effectively removes any air in the chamber so that a weld can be completed without any undesired gas near the weld seam.

### CROSS REFERENCE TO RELATED APPLICATION

This application claims priority to U.S. Provisional Application No. 63/170,019 which was filed on Apr. 2, 2021.

### BACKGROUND

Weld purging includes removing oxygen and water vapor from the vicinity of a welding joint. In the absence of weld purging, oxygen and hydrogen may combine with the hot metal to form undesirable compounds that may reduce corrosion resistance and otherwise weaken the welding joint. A common method to remove these gases from a weld is by flushing them away with an inert gas, such as argon.

When welding together sections of pipe, a clean weld is required inside and outside the pipe. Weld purging on the outside of the pipe is accomplished through a supply of inert gas through the welding wand, itself. Traditionally, purging the inside of the pipe has been effectuated by introducing inert gas into the pipe to push out the natural atmosphere. The amount of inert gas and the time required increases with increased pipe sizes. In some situations, this causes undesirable welder downtime and excessive inert gas consumption.

### SUMMARY

A system for welding pipe sections together includes first and second disks, each having a central portion and a resilient material outer portion. The central portion is more rigid than the outer portion. An outside dimension and shape of each outer portion is configured to engage an interior of a pipe having an inner dimension that is smaller than the outside dimension of the outer portion to establish a sealed interface between the outer portion and the interior of the first pipe section. The disks establish a chamber that overlaps a weld seam between abutting pipe sections. An inert gas introduced into the chamber effectively removes any air in the chamber so that a weld can be completed without any undesired gas near the weld seam.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 diagrammatically illustrates an example embodiment of a system in perspective view.

FIG. 2 shows the embodiment of FIG. 1 in use within pipe sections.

FIG. 3 is a flowchart diagram summarizing an example method of using a system like that shown in FIGS. 1 and 2.

### DETAILED DESCRIPTION

Embodiments of this invention facilitate welding pipe sections together by establishing a chamber within the pipe where inert gas can replace air that is otherwise present and would interfere with achieving a good quality weld.

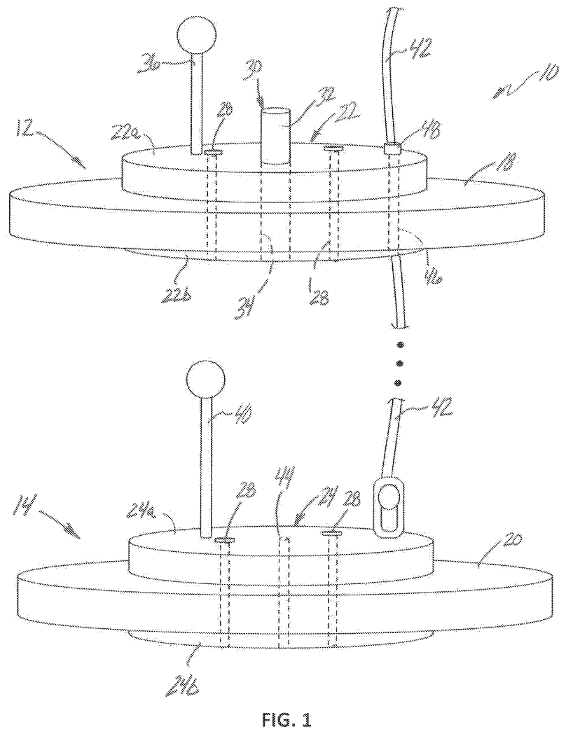

FIG. 1 shows an example embodiment of a system 10 for establishing a chamber to purge undesired gases near a seam between two pipe sections that are to be welded together. The example system 10 includes a first disk 12 and a second disk 14. The disks 12 and 14 are configured to serve as walls or ends of a chamber from which any undesired gases are purged.

The first disk 12 includes a resilient outer portion 18 and a central portion 22. The second disk 14 includes a resilient outer portion 20 and a central portion 24. The central portions 22, 24 are more rigid than the resilient outer portions. In the illustrated example, the central portions 22, 24 each include two plates or sheets 22a, 22b, 24a, 24b that sandwich at least some of the resilient material that establishes the corresponding outer portion 18, 20.

The disks 12, 14 are each capable of establishing a sealed barrier within a pipe. The resilient outer portions 18, 20 may be considered flexible seal portions that are configured to engage an interior surface on a pipe section to establish a sealed interface between the disk and the pipe. In some embodiments, the resilient outer portions 18, 20 comprise a durable, natural gum rubber that is ¼ inch thick. The more rigid central portions 22, 24 in the illustrated example comprise plates or sheets of high-density polyethylene plastic that is ¼ inch thick. Fasteners 28, such as screws or bolts, secure the plates of the central portions 22, 24 together on opposite sides of the resilient material.

Although the example disks 12 and 14 have a sandwich or layered construction, other embodiments are constructed differently. For example, the disks 12 and 14 can have a single-layer construction with a ring of the resilient material that establishes the outer portion 18, 20 secured around a periphery of a more rigid central portion.

The first disk 12 includes an inlet 30 that includes a resilient tube 32 protruding from one side of the central portion 22. An inlet passage 34 extends through the central portion 22 of the first disk 12. The resilient tube 32 is configured to be coupled with a source of an inert gas, such as argon.

A handle 36 is connected with the central portion 22 in an off-center position. The handle 36 is useful for manipulating the disk 12 relative to an inside of a pipe to position the disk in a desired location during installation or to remove the disk 12 from the pipe. The handle 36 includes at least one surface that can be grasped by a user for manipulating the disk 12. In some embodiments, the handle 36 is part of the rigid central portion. In the illustrated example, the handle 36 comprises additional hardware secured to the central portion 22. In the illustrated example embodiment, the handle 36 includes a spherical end. In other embodiments, the handle 36 comprises at least one eyebolt or similar hardware that facilitates manipulating the disk 12 into or out of a position within a pipe. The off-center position of the handle 36 makes it easier to remove the disk 12 from a pipe in which the flexible outer portion 18 engages an inner surface of a pipe.

The second disk 14 includes a similar handle 40 that is useful for manipulating the disk 14 relative to an interior of a pipe section. An elongated retrieval member 42 is secured to the central portion 24 in an off-center position. The elongated retrieval member in this embodiment comprises a cable, such as a steel or polymer strand cable. The second disk 14 also includes a centrally located opening or through passage 44.

The retrieval cable 42 extends through a passage 46 in the central portion 22 of the first disk 12 so that part of the cable 42 extends between the disks 12 and 14 and another portion extends beyond the first disk 12. In this example embodiment, a sleeve member 48 near at least one of the passage 46 is received about the cable 42. The sleeve may but need not establish a partially sealed interface around the cable 42.

At least one of the disks 12 and 14 in some embodiments include a cover plate or label, which is laid over the rigid central portions 22, 24. The cover plates may include size and branding information and serves to protect the central portions 22, 24. The cover plates 33 may be a thin gauge aluminum or stainless-steel plate.

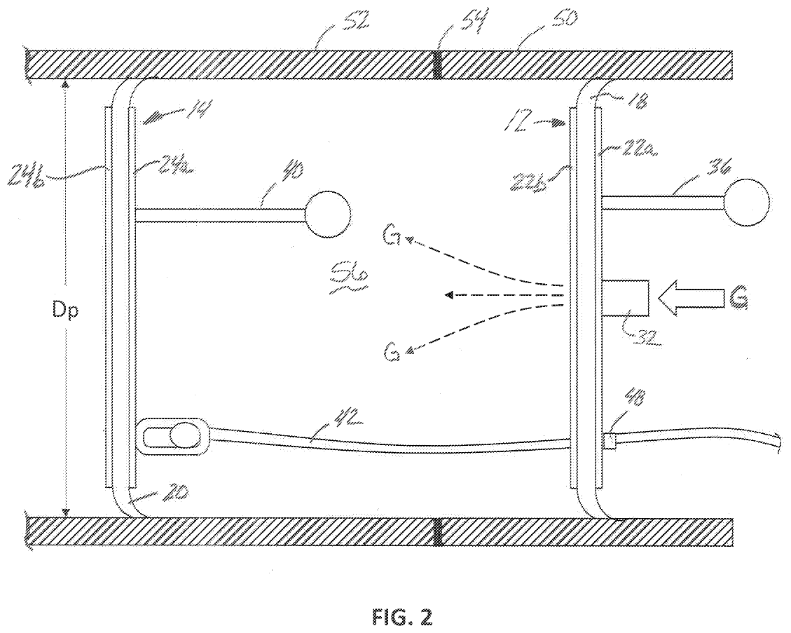

FIG. 2 illustrates the system 10 in use to weld a first pipe portion 50 to a second pipe portion 52 at a weld joint 54. The second disk 14 is positioned within the second pipe portion 52 and the first disk 12 is positioned within the first pipe portion 50 such that the disks 12 and 14 straddle the weld joint 54. The first disk 12 and the second disk 14 establish or form a chamber 56 between them when the ends of the pipe portions 50 and 52 are aligned as illustrated.

An inert gas supply is connected to the sleeve 32 to introduce pressurized inert gas G into the isolated chamber 56. The inert gas G is preferably argon, but may be helium or nitrogen. Tape may be applied around the weld joint 54 where the ends of the pipe portions abut to better seal the chamber 56. The central hole 44 in the second disk is open and serves as a vent for air to exit the isolated chamber 56 as the chamber 56 becomes essentially filled with the inert gas G. Other openings may be included or used as a vent. For example, the hole 46 through which the retrieval cable 30 is received is some embodiments is not sealed and, therefore, allows for some venting of air from the isolated chamber 56.

The chamber 56 established by the system 10 reduces the volume of atmospheric air that needs to be removed from inside the pipe near the weld joint 54. Instead of having to essentially fill an entire length of the pipe sections prior to welding, only the chamber 56 needs to be filled with enough inert gas to minimize or eliminate undesired gas from the vicinity of the weld seam 54. For example, the first pipe section 50 may be added on to a significantly long second pipe section 52. Purging the entire interior of both pipes prior to welding wastes valuable welder time and inert gas. In contrast, the example system 10 allows a welder to much more quickly and economically purge atmospheric gas from the isolated chamber 56, which advantageously decreases the amount of time spent waiting for the inert gas supply to flush out atmospheric gas and the amount of inert gas needed.

Once a weld is completed, a user may remove the disks 12 and 14 from inside the welded pipe by pulling on the handle 36 to remove the first disk 12. Once the first disk 12 is out of the way, the second disk 14 may be removed by grabbing the handle 40 and manipulating the second disk 14 to remove it. If the distance to the weld seam 54 is too far into the pipe to reach the handle 40, the retrieval cable 42 can be pulled to remove the second disk 14.

In some situations, the cable 40 facilitates removing both of the disks 14 and 12 from the open end of the pipe. The retrieval cable 42 facilitates removing the disks 12, 14 when the location of the weld is deep enough within an open-ended pipe where neither handle 36 or 40 is accessible. The off-center location of the retrieval cable 42 facilitates tilting the first and second disks 12 and 14 relative to the interior of the pipe, which makes removing the disks easier

The resilient outer portions 18, 20 and the central portions 22, 24 may be dimensioned to work appropriately for various pipe diameters. The resilient outer portions 18, 20 have an outer dimension or diameter (D_{f}) that is larger than the inner diameter Dₚ of the pipe in which the system 10 will be used. Accordingly, when the disks 12, 14 are placed within a pipe, the outer portions 18, 20 flex or bend (as shown in FIG. 2) and press against the inner walls of the pipe to form a seal along the interface between the disks and the interior of the pipe.

A ratio of the outer diameter of the outer portions (D_{f}) to the pipe inner diameter (Dₚ) is preferably between 1.0 and 1.5. In some example embodiments, the ratio D_{f} to Dₚ is between 1.06 and 1.25. These ranges assist in achieving an appropriate seal along the interior of the pipes to be welded together while also facilitating inserting and removing the disks 12 and 14.

The plates 22a, 21b, 24a and 24b of the central portions 22, 24 include a diameter (D_{c}), which may also be varied to be appropriate for a specific pipe size. A ratio of D_{c} to pipe diameter Dₚ is preferably between 0.5 and 0.9. In some embodiments, the ratio of D_{c} to Dₚ is between 0.62 and 0.84. Additionally, a ratio of D_{c} to D_{f} is preferably between 0.4 and 0.85. In some embodiments, the ratio of D_{c} to D_{f} is between 0.5 and 0.78. The ratios of D_{c}/Dₚ and D_{c}/D_{f} both assist in giving the disks 12, 14 sufficient rigidity to be manipulated into place where they remain until the chamber 56 is no longer needed (i.e., after the weld is complete) and contribute to forming an appropriate seal.

Nine exemplary configurations of the dimensions D_{f}, D_{c} and Dₚ are provided in Table 1 below:

TABLE 1

| Pipe | | | | | |
|---|---|---|---|---|---|
| Diameter, | Flexible Seal | Rigid Center | | | |
| Dₚ | Diameter, D_{f} | Diameter, D_{c} | D_{f}/Dₚ | D_{c}/Dₚ | D_{c}/D_{f} |
| 3″ | 3.75″ | 1.875″ | 1.2500 | 0.6250 | 0.5000 |
| 4″ | 4.75″ | 2.5″ | 1.1875 | 0.6250 | 0.5263 |
| 6″ | 7.25″ | 4″ | 1.2083 | 0.6667 | 0.5517 |
| 8″ | 9.75″ | 6″ | 1.2188 | 0.7500 | 0.6154 |
| 10″ | 11.75″ | 7.625″ | 1.1750 | 0.7625 | 0.6489 |
| 12″ | 13.75″ | 9.5″ | 1.1458 | 0.7917 | 0.6909 |
| 14″ | 15.25″ | 10.75″ | 1.0893 | 0.7679 | 0.7049 |
| 16″ | 17.25″ | 13″ | 1.0781 | 0.8125 | 0.7536 |
| 18″ | 19.25″ | 15″ | 1.0694 | 0.8333 | 0.7792 |

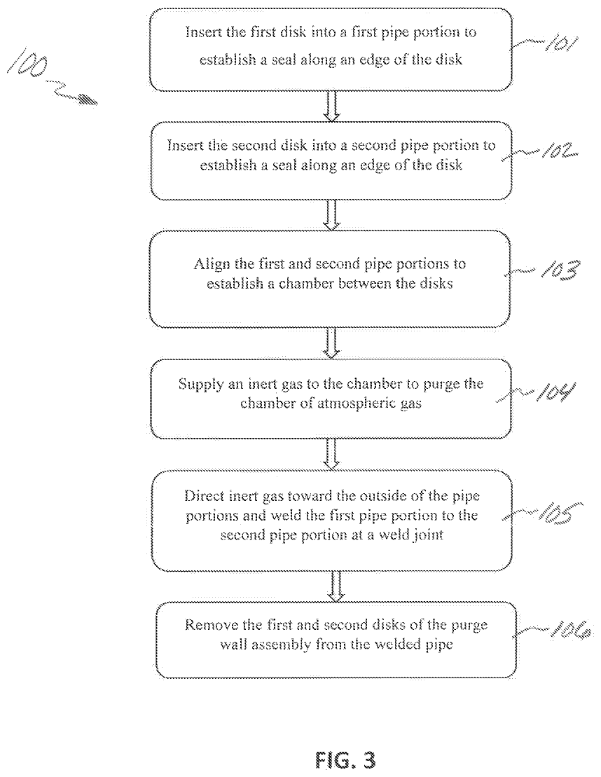

FIG. 3 is a flow chart diagram 100 that summarizes a method of welding pipe sections together using the system 10. Step 101 includes inserting the first disk 12 into a first pipe portion 50 to establish a first seal between the outer edge of the disk 12 and the interior of the first pipe 50. Step 102 includes inserting the second disk 14 into a second pipe portion 52 to establish a second seal around the interior of that pipe. Step 103 includes aligning the first and second pipe portions 50 and 52 with the ends where the weld seam 54 is desired abutting each other. In that position, the disks 12 and 14 are situated a sufficient distance from the abutting edges of the pipes portions to establish an isolated chamber 56 between them. Step 104 includes introducing an inert gas to the isolated chamber 56 through the inlet 30 until a sufficient volume of the inert gas within the chamber 56 effectively purges the isolated chamber 56 of atmospheric gas. Step 105 includes directing inert gas toward the outside of the pipe portions in the vicinity of the weld seam 54 with a welding wand and welding the first pipe portion 50 to the second pipe portion 52. Step 106 includes removing the first and second disks 12, 14 from the welded pipe portions 40, 42 after the weld is complete and sufficiently cooled.

Although a particular component arrangement is disclosed and illustrated, other arrangements may become apparent to those skilled in the art who have the benefit of this disclosure. Placement and orientation of the various components of the illustrated embodiments could vary from the illustrated example. In addition, the drawings accompanying this disclosure are not necessarily drawn to scale, and some features may be exaggerated or minimized to emphasize certain details of a particular component.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A system for welding pipe sections together, the system comprising:
a first disk having a central portion and an outer portion, wherein
the outer portion of the first disk comprises a resilient material,
the central portion of the first disk is more rigid than the outer portion,
an outside dimension and shape of the outer portion of the first disk is configured to engage an interior of a first pipe section having an inner dimension that is smaller than the outside dimension of the outer portion to establish a sealed interface between the outer portion and the interior of the first pipe section,
the first disk includes an inlet on a first side of the first disk, and
the first disk includes at least one handle configured to facilitate moving the first disk within the interior of the first pipe section; and
a second disk having a central portion and an outer portion, wherein
the outer portion of the second disk comprises a resilient material,
the central portion of the second disk is more rigid than the outer portion,
an outside dimension and shape of the outer portion of the second disk is configured to engage an interior of a second pipe section having an inner dimension that is smaller than the outside dimension of the outer portion to establish a sealed interface between the outer portion and the interior of the second pipe section, and
the second disk includes at least one elongated retrieval member configured to facilitate removing at least the second disk from within the interior of the second pipe section.

2. The system of claim 1, wherein
the inlet is configured to be coupled with a source of an inert gas,
the inlet allows inert gas from a source on the first side of the first disk to pass through to a second side of the first disk.

3. The system of claim 2, wherein the inlet comprises a resilient tube.

4. The system of claim 1, wherein the central portion comprises at least one plate made of a second material that is different than the resilient material of the outer portion.

5. The system of claim 4, wherein the resilient material comprises rubber and the second material comprises high density polyethylene.

6. The system of claim 1, wherein the second disk includes a vent passage extending from one side of the second disk to an opposite side of the second disk.

7. The system of claim 1, wherein each of the first disk and the second disk includes a handle configured to be gripped for manipulating the corresponding disk relative to an interior of a pipe when the disk is inside the pipe.

8. The system of claim 7, wherein each handle is located off-center from a center of the corresponding disk.

9. The system of claim 1, wherein the first disk includes a passage through which at least a portion of the elongated retrieval member is received.

10. The system of claim 9, wherein the elongated retrieval member is configured to facilitate removing the first disk and the second disk from a pipe.

11. The system of claim 1, wherein a ratio of the outside dimension of each disk to the inner dimension of the pipe portions is between 1.0 and 1.5.

12. The system of claim 1, wherein
the central portion has a second dimension that is smaller than the outside dimension of the outer portion, and
a ratio of the second dimension to the inner dimension of the pipe portions is between 0.5 and 0.9.

13. The system of claim 1, wherein
the central portion has a second dimension that is smaller than the outside dimension of the outer portion, and
a ratio of the second dimension to the outside dimension of the outer portion is between 0.4 and 0.85.

14. A method of welding pipe sections, the method comprising:
situating a first disk in a first pipe portion to establish a seal along an interface between the first disk and the first pipe portion;
situating a second disk in a second pipe portion to establish a seal along an interface between the second disk and the second pipe portion;
positioning an end of the first pipe portion against an end of the second pipe portion wherein the first disk and the second disk establish a chamber within the pipe portions between the disks;
introducing an inert gas into the chamber to replace at least a majority of air in the chamber with the inert gas; and
welding the first pipe portion to the second pipe portion while the inert gas is in the chamber.

15. The method of claim 14, wherein the inert gas is one of argon, helium, and nitrogen.

16. The method of claim 14, comprising directing inert gas toward an outside of the first and second pipe portions with a welding wand.

17. The method of claim 14, comprising removing the first and second disks from the first and second pipe portions subsequent to the welding.

18. The method of claim 14, wherein the first and second disks each include a resilient outer portion and a central portion that is more rigid than the outer portion.
